(19) United States
(12) Patent Application Publication
(10) Pub. No.: US 2008/0153509 A1
(43) Pub. Date: Jun. 26, 2008

(54) Method for locating a mobile communication device

(76) Inventor: Christopher Piekarski, Boulder, CO (US)

Correspondence Address: ROBERT C. SCHLUER, 45 GROTON ROAD, SHIRLEY, MA, 01464, US

(21) Appl. No.: 11/643,510

(22) Filed: Dec. 21, 2006

(51) Int. Cl. H04Q 7/20

(52) U.S. Cl. 455/456.2

(57) ABSTRACT

A wireless communication network includes a number of wireless communication devices capable of sending and receiving wireless communication signals and capable of receiving geographic positioning signals from a satellite that they can use to calculate their geographic position. In the event that one wireless communication device moves into an environment in which it is unable to receive a geographic positioning signal, this wireless device is able to establish an ad hoc network with at least two other wireless devices in the network and to retrieve geographic position information from the two other devices. Furthermore, this device can use time of flight information between itself and the other two wireless devices to calculate the distances between it and each of the two other wireless devices that can be utilized to calculate, in combination with the geographic positions of the other two wireless devices, its geographic position.

### FIELD OF INVENTION

My invention relates generally to the area of locating a mobile communications device and specifically to the location of such a device with combined global positioning and wireless communication capability.

### BACKGROUND

Mobile communications devices are now often used in the reporting of emergency situations by those on the scene. Typically, the first question asked of the person reporting the emergency is the location at which the emergency is happening. The person reporting the emergency then has to describe to the emergency operator exactly where, Town and street address for instance, the emergency is transpiring. The persons reporting such emergencies very often find themselves in highly stressful environments and/or are at a location that is not familiar to them which makes communicating such things as the location of the emergency problematical.

Mobile communications devices are now available that include global positioning system (GPS) receivers that automatically transmit location information calculated from information received from three or more GPS satellites to the emergency operator during an emergency “911” call. Operating in this manner, the person placing the emergency call does not have to be concerned with providing the emergency operator with the location of the emergency. Typically, GPS signals are transmitted at relatively low power levels and so only propagate well through the air which make receiving such signals difficult when a mobile communications device is located inside a structure, in a forested area, in a tunnel, or when some other obstruction comes between the GPS satellite and the GPS receiver located in the mobile device. In such environments, mobile communication devices using GPS signals are not able to transmit their location during to an emergency operator during an emergency call.

U.S. Pat. No. 5,999,124 describes a mobile communications device that includes a GPS receiver and the capability to determine location based on cellular (GSM) transmissions received from several, typically two or more, fixed cellular base stations located at a cell tower for instance. While this arrangement does enable a mobile communication device to determine its location while in environments obstructed from GPS signals, it is dependent upon receiving transmissions from at least three cell towers in order to determine its location, and a mobile communications device is not always within range of three cell towers.

Therefore, it is advantageous if a mobile communication device can, when blocked from receiving GPS signals, take more complete advantage of the cellular communication system in order to determine location information. A wireless device that is not able to receive GPS signals can form an ad hoc network with at least two other wireless communication devices and using the positions of the two other wireless devices that are able to receive GPS signals can then use the round trip time of cellular transmissions to determine location.

### SUMMARY OF THE INVENTION

In the preferred embodiment of my invention, an ad hoc communication network is established between at least three wireless communication devices each capable of receiving GPS information from a satellite and in the event that one of the wireless communication devices determines that it is unable to receive GPS signals, it sends message requesting the other wireless devices for their GPS information and uses the response from these devices to measure the signal strength of each communications link, it then sends another message that requests an immediate response and the round trip time of the request and response messages are determined, it then uses the GPS positions of the other wireless devices and the round trip times of the messages to calculate and store its geographic position.

### BRIEF DESCRIPTION OF THE DRAWINGS

FIG. 1 is a diagram showing the prior art GPS/GSM positioning system infrastructure.

FIG. 2 is a diagram showing the positioning system of the invention.

FIG. 3 is a high level block diagram of a wireless communication device with both GSM and GPS location determination capability.

FIG. 4a is a diagram showing the format of an admin packet used to signal for location help.

FIG. 4b is a diagram showing the format of a data packet used to respond to the location help signal of FIG. 4a.

FIG. 4c is a diagram showing the format of an admin packet used to clear the wireless medium.

FIG. 4d is a diagram showing the format of an admin timing packet used to calculate RTT.

FIG. 4e is a diagram showing the format of a data packet send in response to the packet in FIG. 4d.

FIG. 5a is a logical flow chart of the method of the invention FIG. 5b is a continuation of the flow chart of FIG. 5a.

### DETAILED DESCRIPTION OF THE INVENTION

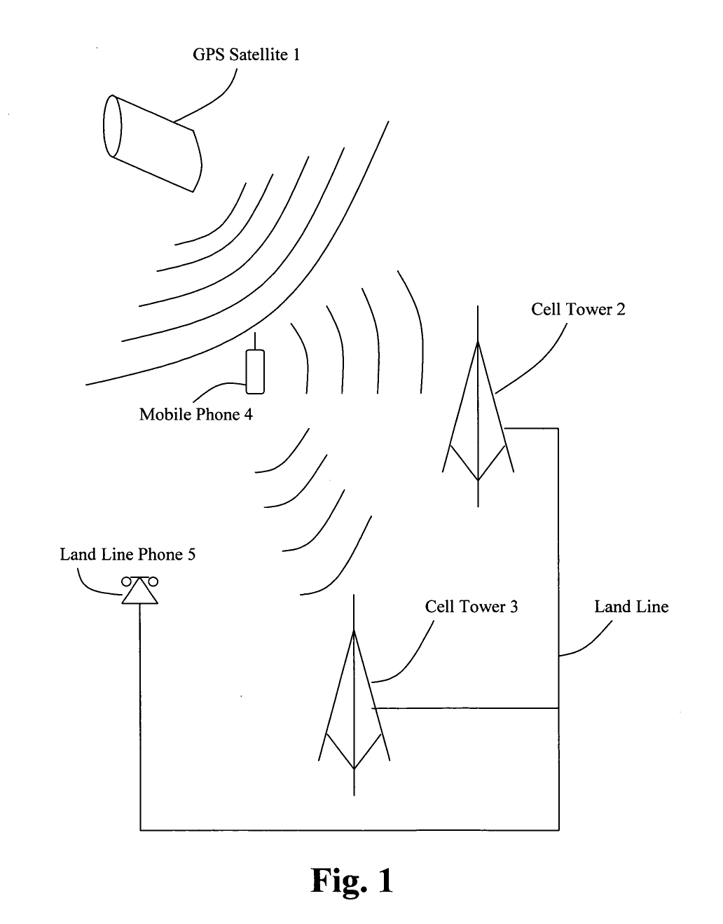

FIG. 1 shows the various infrastructure devices needed to operate a prior art positioning system. The infrastructure of such a positioning system consists of at least one, but typically twenty-four, global positioning system (GPS) satellites 1, two or more fixed position cell towers 2 & 3, and at least one GSM capable mobile phone 4 that includes a GPS receiver. Also, the GSM capable mobile phone can make emergency “911” calls to an emergency operator at land line phone 5 that include, among other things, location information. In operation, the mobile phone 4 receives transmissions from a number of GPS satellites (preferably at least three) and uses information included in the transmissions to calculate its geographic position. Typically this information includes such things as reference clock time and satellite orbital information. In addition to being able to determine its position based on transmissions from GPS satellites, mobile phone 4 is able to utilize GSM or cellular transmissions to determine its geographic position by using the difference in a measured round trip time between several (preferably two or more) cellular base stations or cell towers. Mobile phone 4, can determine its geographic location by determining its distance from two known geographic positions, which in this case are the two cellular base stations 2 and 3. Generally, to determine the distance from the mobile phone to the base stations, the mobile phone transmits a signal to each one of the base stations which immediately respond by transmitting a signal back to the mobile phone. The time that it takes each signal to travel from the mobile phone to each of the base stations and back (round trip time or RTT) is measured, divided by two and multiplied by the speed of light to arrive at the distance the mobile phone is from each base station. Then, knowing the geographic positions of each base station, the position of the cell phone can be determined using triangulation techniques.

The GPS based position determination method works well when the mobile phone is able to receive transmissions from several GPS satellites; however, in the event that the mobile phone is not able to receive transmissions, such as when it is inside a building or in a forested area, etc., then the mobile phone has to rely on the previously described GMS positioning method. But, in the event that the mobile phone is not within range of at least two cellular base stations, then it is not possible for the mobile phone to determine its geographic coordinates using the GMS method. And further, in the event that the mobile phone is not able to receive GPS transmissions and is also not within range of at least two base stations, then it is not possible for the mobile phone to determine its geographic location. However, the method of my invention extends the capabilities/coverage of the GSM position determination method described above by providing the mobile phone with an alternative method for determining its geographic position by establishing an ad hoc network with two other mobile phones within range and which are able to receive GPS transmissions.

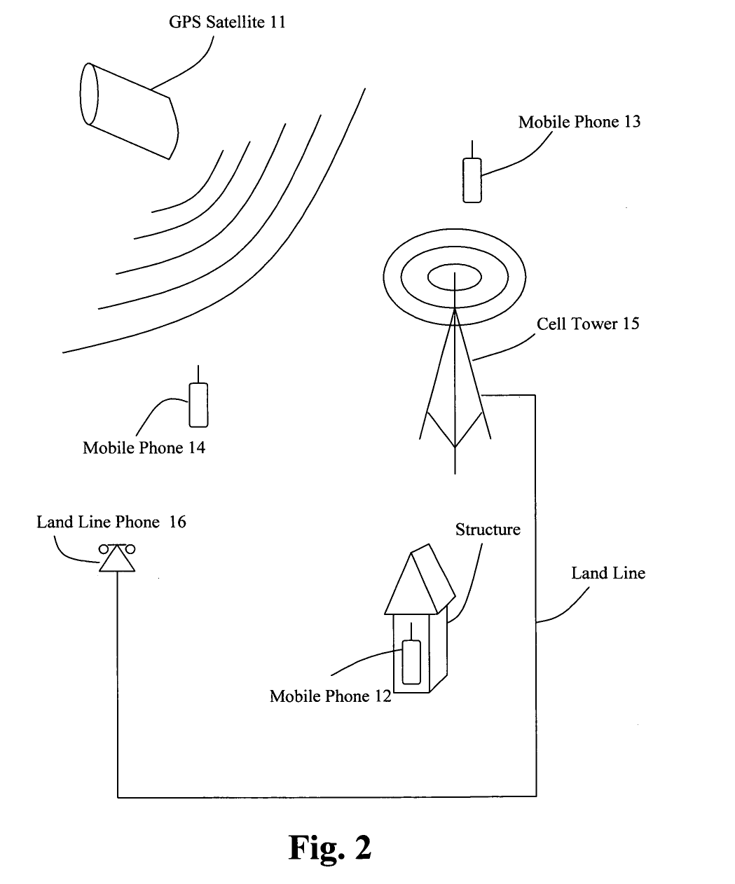

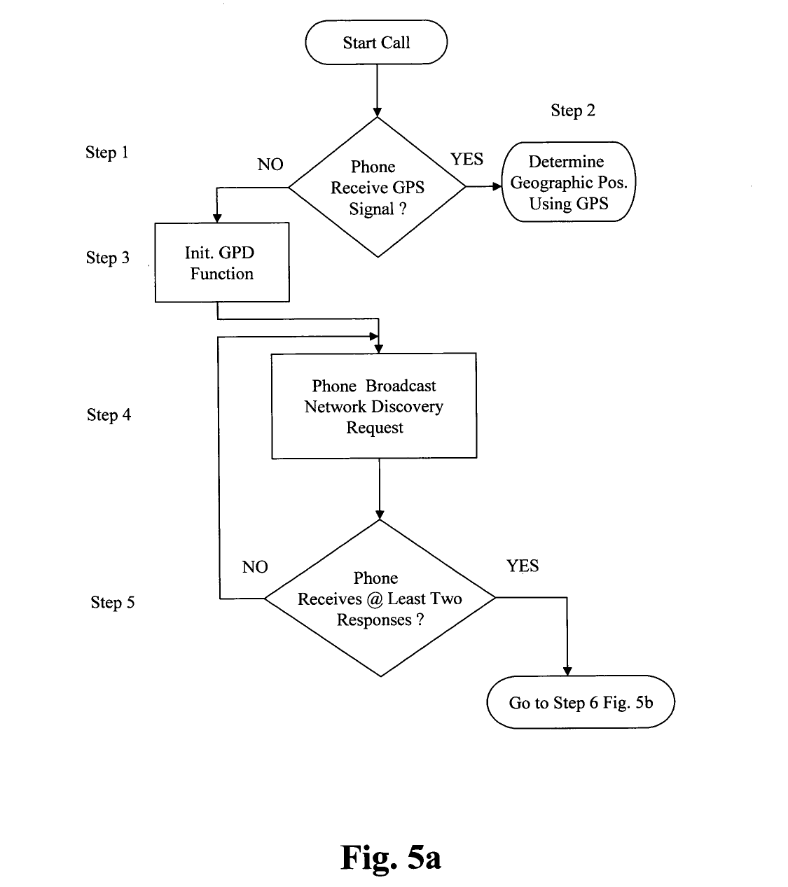

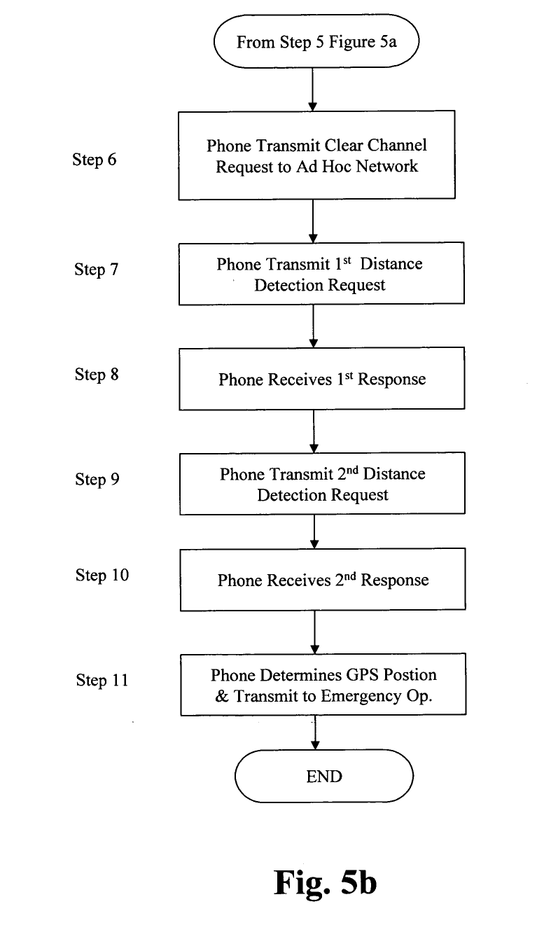

FIG. 2 is a diagram showing the various infrastructure elements necessary for the operation of the geographic positioning method of my invention. At the highest level, the geographic positioning system infrastructure is comprised of some number of GPS satellites 11 (typically twenty four) and mobile phones 12, 13 & 14 capable of wireless communication using any one of the many cellular or wireless communication technologies available [list several technologies here]. The mobile phones also include a GPS module for receiving and processing transmissions from GPS satellites. The system infrastructure would typically also include a number of cell towers, one of which is shown as cell tower 15, with cellular base stations and an emergency operator 16 connected to the cellular communication system over a wired land line interface and typically located at a police or fire station in a town. If all of the mobile phones have an unobstructed line of sight to a GPS satellite, they are all able to receive transmissions from the satellite and therefore able to determine their geographic positions using information included in these transmissions only. However, in the event that any one or more of the mobile phones roams into an environment where it is not possible to receive a GPS transmission, such as into a forested area or a structure of some sort, and the mobile phone is within range of less than two cell base stations, it is advantageous to employ the method of my invention to determine the geographic position of the mobile phone. In operation, the GPS satellites 11 as previously mentioned, periodically transmit signals that contain orbital and reference clock information that are received by the mobile phones 13 and 14, in this case, which use this information to calculate their geographic positions. As mobile phone 12 is located in an environment which blocks the transmission of GPS signals, this phone is not able to determine its geographic location using GPS information. In this case, preferably mobile phone 12 determines its geographic position by initiating of an ad hoc network with at least two other phones that are able to receive GPS transmissions, which in this case are mobile phones 13 and 14, and gathering the necessary information about the distance to mobile phones 13 and 14 and GPS information from phone 13 and 14 to determine its position. More specifically, mobile phone 12 requests GPS information stored at mobile phones 13 and 14, determines its distance from both phones 13 and 14 by measuring a message round trip time, and then uses this information to determine its geographic position. I will describe how my invention works in greater detail later with reference to FIG. 5.

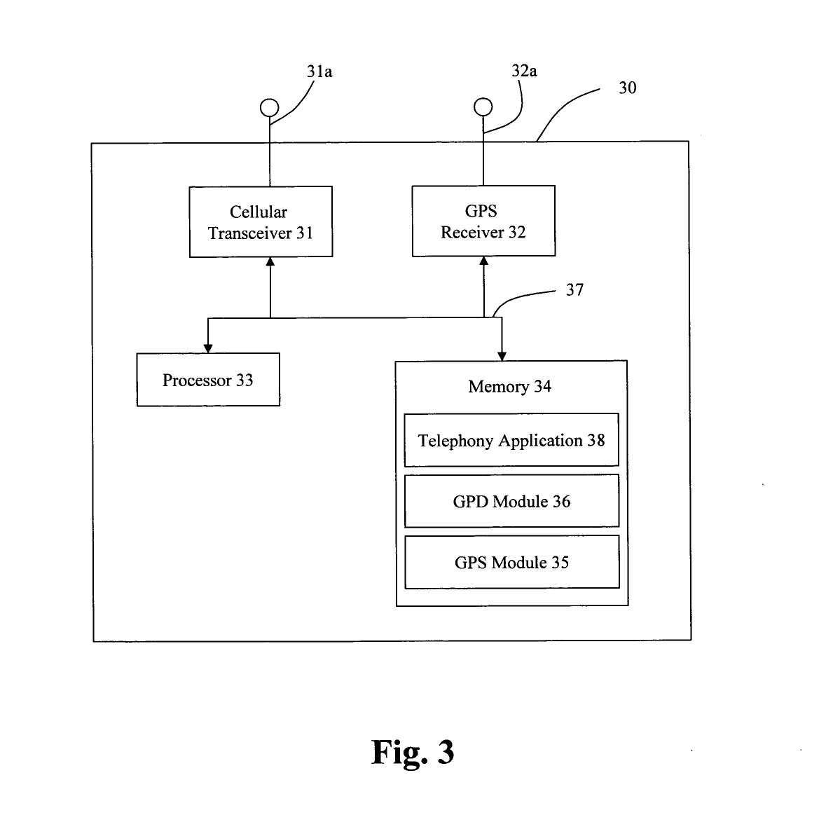

FIG. 3 is a high level functional block diagram of any one of the mobile phones 12, 13 or 14 shown in FIG. 2. All of these mobile phones can employ the same cellular communications technology, GSM for instance, or operate using different technology, GSM, TDMA, and PCS for instance or any other wireless communication technology with sufficient transmission range to accommodate the needs of my invention. It is not important what the same cellular technology is used in each phone as long as each phone is able to communicate directly with each other phone in the ad hoc network. The mobile phone of FIG. 3 has a cellular transceiver 31 for receiving and transmitting signals over the air using any of the cellular communication technologies mentioned above. The mobile phone also has a GPS receiver for receiving GPS satellite transmissions and both the GPS receiver and the GSM transceiver are connected to antennas, 32a and 31a respectively, which serve as the initial point of reception for a wireless signal and to propagate the wireless signals over the air. The GMS transceiver and the GPS receiver are both connected to a bus 37 that distributes information to the various other mobile phone functional components described hereinafter. A microprocessor 33 connected to the bus 37 generally operates in conjunction with memory 34 and under the control of a telephone application 38 described later to coordinate and perform certain functions necessary to the operation of the mobile phone. This includes, among other things, such functionality as initiating and ending communication sessions and in this case directing an application in memory 34 to calculate a geographic position using information contained in cellular transmissions and information contained in GPS transmissions. The memory 34 generally serves to store applications the mobile phone employs for its operation, such as the telephony module 38 mentioned above, and in this case is used to store a geographic position determination (GPD) module 36 that is used by the mobile phone, in conjunction with the telephony application to generate position determination message for transmission and to process information received from other mobile phones in order to calculate geographic position information that can be transmitted with an emergency call, for instance. The memory 34 also is used to store a GPS module 35 which serves to receive and process GPS information from the GPS receiver. In operation, when the user of a mobile phone wishes to make an emergency call after carrying the mobile phone into an environment where it is not able to receive GPS transmissions, upon initiating the emergency call, the GPD module initiates a process to establish an ad hoc network with other mobile phones within its range that are currently able to receive GPS transmissions. As the result of establishing the ad hoc network, the mobile phone receives GPS coordinate information from the other mobile phones in the network. The GPD module then performs some other operations, described later in more detail with reference to FIG. 5, that result in the mobile phone determining is distance from each of the other mobile phones in the ad hoc network. The GPD module in the mobile phone then uses the GPS coordinate information received from the other phones and the distance information from the other phones to determine its geographic position and transmits this geographic position information with the audio information in the emergency call to the operator.

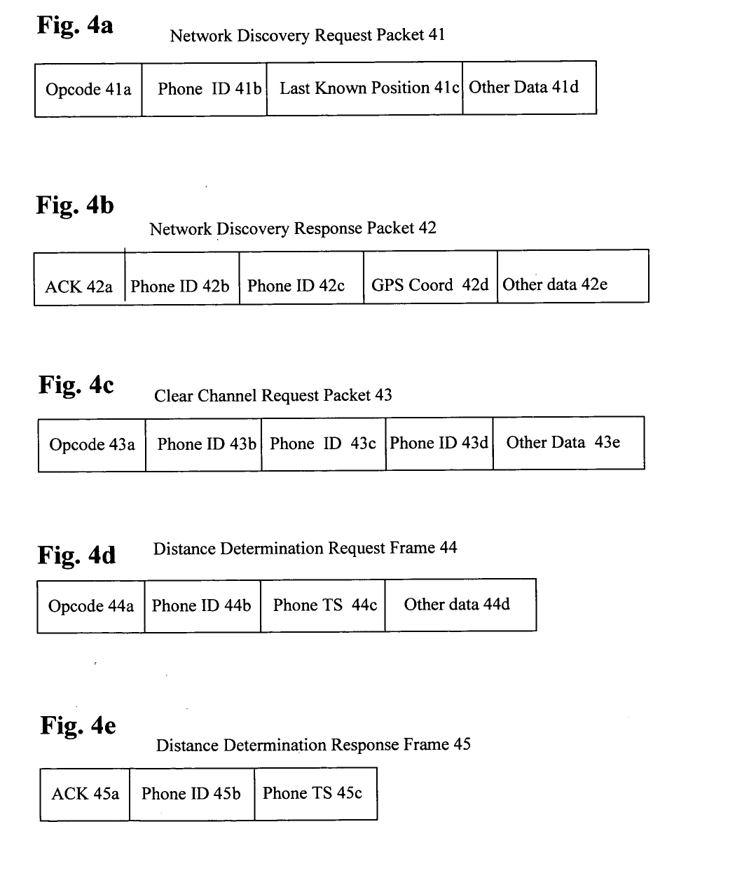

FIGS. 4a, 4b, 4c, 4d and 4e serve to illustrate the packet formats of messages used to establish the ad hoc network, described above with reference to FIG. 2 and FIG. 3, and used to calculate the distances between the mobile phones in the ad hoc network. Starting with FIG. 4a, a network discovery request message includes an admin packet 41, formatted to include at least four fields labeled 41a-d, is broadcast by a mobile phone not currently able to receive GPS transmissions, mobile phone 12 in FIG. 2 for instance. Field 41a is used to transmit opcode information which is a unique command indicating to the other mobile phones, 13 and 14 in FIG. 2 for instance, that this is a message requesting their current GPS information. Field 41b contains device or phone identifier information about mobile phone 12 that the mobile phone receiving the message uses in order to address the return message. Field 41c contains optional information about the last known position of mobile phone 12. This last know position information is the last reference clock and satellite orbital information receive by mobile phone 12 before it moved into an environment in which it could no longer receive a GPS transmission. Field 41d may or may not include any information depending upon whether it is desirable to send some other information along with the message such as the type of device (mobile phone or laptop) or whether the message is being transmitted from a vehicle or a boat for instance.

FIG. 4b illustrates the format of a data packet 42 transmitted by either or both of the mobile phones 13 and 14 in a network discover response message in response to receiving the message described above with reference to FIG. 4a. Field 42a contains information indicating that the message is being sent in acknowledgement (ACK) of receiving the message transmitted by mobile phone 12 and described in FIG. 4a. This packet also includes a phone identifier field 42b that mobile phone 12 uses to build a list of mobile phones which it includes as members of the ad hoc network. Field 42c includes phone identification information about mobile phone 12 which serves to notify this phone that the ACK is directed to it. Field 42d includes GPS coordinate information relative to the position of either or both of phones 13 and 14 and field 42e may contain some other information not related to the operation of my invention.

FIG. 4c shows the format of an admin packet 43 used by mobile phone 12 to generate a clear channel message that is broadcast or multicast to at least both of the mobile phones 13 and 14 and any other mobile phones within range of the message. The field 43a is an opcode that alerts both the mobile phones 13 and 14 that this message will be immediately followed by a message directed to each of these mobile phones requesting an immediate response. By immediate in this context I mean that the next message will be transmitted after a SIFS (short inter-frame space) time or after a clear to send (CTS) time. Field 43b again includes mobile phone 12's network identification information used to address the response message and fields 43c and 43d include the network identification information of each mobile phone to which this message is being transmitted, which in this case is to mobile phones 13 and 14. Field 43e may contain other information not relevant to the operation of my invention. The effect of this message is to clear the communication channel used by at least the devices in the ad hoc network and possibly all device within range of mobile phone 12 so as to ensure that the next messages sent by this phone to determine range information will be sent sequentially with the minimum of inter frame delay. The reason for clearing the channel will be described below with reference to FIG. 4d.

FIG. 4d shows the packet format 44 of a distance determination request message sent to each of the mobile phones in the ad hoc network, which in this case are phones 13 and 14. These messages are sent in sequence with only a minimum inter frame time delay. Minimizing this delay is important as all three of the mobile phones, 12, 13 and 14, could be moving with respect to one another, and since the accuracy of my geographic position determination method depends in part upon making distance measurements between, in this case, mobile phones 12 and 13 and 12 and 14 at a single point in time. Any movement that takes place after mobile phone 12 transmits one message to phone 13 and another message to phone 14 only adds to the error when calculating the geographic position of phone 12. Field 44a contains an opcode indicating to the receiving mobile phones that this message is a distance determination request and that the receiving phones should respond with an ACK message after a minimum of delay. Field 44b includes the network identification information of the mobile phone to which the request is being sent and field 44c include a time stamp which is indicative of the time that the message from transmitted. This time stamp information can be used later to determine the round trip time of the request/response message pair. Field 44d may include other information not relevant to the operation of my invention.

FIG. 4e shows the packet format 45 of a distance determination response message transmitted by each of the mobile phones in the ad hoc network that receive the distance determination request message described above. Field 45a contains information alerting the receiving mobile phone 12 that this is an ACK to the earlier request message. Field 45b include the network identification information of the transmitting mobile phone and field 45c includes a timestamp indicative of the time the request message was sent by mobile phone 12. Use of the messages described with reference to FIGS. 4a-4e above to implement the novel phone position determination method of my invention will be described in detail with reference to FIG. 5 below.

FIG. 5a is a logical flow diagram of the preferred embodiment of the geographic position determination method of my invention. Although I described my invention in terms of mobile phones employing both GPS and cellular technology, it should be understood that my invention will operate with any satellite positioning technology and many wireless communication technologies. One of the requirements for the wireless communication technology is that it can establish a communications session with a wide area communications network, such as POTS or any other network that is used for such activity as emergency communications or any other activity that requires the geographic position of a mobile phone to be known. After a call has been initiated that necessitates the geographic position of the mobile phone, which is phone 12 in this case, in step 1 the mobile phone 12 employs its GPS module to determine whether the phone is currently receiving GPS transmissions. If mobile phone 12 is currently receiving GPS transmissions it will determine its current geographic position using information contained in these transmissions and send its position information along with the emergency call to the emergency operator. On the other hand, if the mobile phone 12 roams into an environment that blocks the reception of GPS transmissions, it will in step 3 initialize the GPD module 36 functionality generally described earlier with reference to FIG. 3. As mentioned previously with reference to FIG. 3, the GPD module generally operates in conjunction with the telephony module 38 to generate messages transmitted by mobile phone 12 that request certain information from other mobile phones that are members of the ad hoc network. The GPD module also is used to run certain functions that calculate the geographic position of the mobile phone. A more detailed description of the operation of the GPD module will be undertaken below with reference to the various steps in the position determination process of FIG. 5b. In step 4, the GPD module in conjunction with the telephone module generates and broadcasts the network discover request message described earlier with reference to FIG. 4a to all mobile phones within range. The objective in sending this message is to discover all other suitable mobile phones that are within range and that it is compatible with in order to establish an ad hoc network. By suitable, I mean that it is important that the communication link between mobile phone 12 and the other mobile phones be of sufficient quality so as to minimize any lost or erroneous information during a communication session. Other mobile phones within range that receive the network discovery request signal will respond with a network discovery response message that includes the GPS coordinates of the responding mobile phone. In step 5, mobile phone 12 receives some number of responses to its request in step 4 and measures and stores an indication of the signal quality of the communication link, over which this response message is transmitted, in memory and detects and stores in memory the GPS coordinate information contained in the response message. Further, mobile phone 12 uses the information received in step 5 to create a hierarchical list in memory composed of responding phones according to the quality of the other mobile phones signals. This list represents the mobile phones that could be members of the ad hoc network. If mobile phone 12 does not receive a network discovery response message from at least two other mobile phones, then it proceeds back to step 4 and broadcasts another network discovery request message. On the other hand, if mobile phone 12 receives a response from two or more other mobile phones, phones 13 and 14 of FIG. 2 for instance, it proceeds to step 6 of FIG. 5b, where mobile phone 12 transmits a clear channel request message to at least two mobile phones contained on the hierarchical list. In the preferred embodiment of my invention, mobile phone 12 selects two mobile phones from the list with the two highest quality signals. The clear channel request message has the effect of notifying the mobile phones to which it is sent to expect to receive another message after a minimum inter frame delay. Also, as previously described with reference to FIG. 4c, to the extent that the two or more phones that receive the clear channel request message are able to actually clear the channel, the accuracy of the distance measurement between mobile phones 12 and 13 and 12 and 14 improves. Upon receiving this clear channel request, the two phones, which in this case are mobile phone 13 and 14, would stop transmitting and receiving for a brief period of time or for as long as it takes to receive the next, expected message. In step 7 of FIG. 5b, mobile phone 12 transmits a distance detection request message directed to one of the two mobile phones 13 or 14. Mobile phone 12 places a time stamp on this message that is indicative of the network time that this message was sent. In step 8, mobile phone 13 or 14 receives this message and responds by transmitting an acknowledgment (ACK) back to mobile phone 12. Mobile phone 12 notes the time of receipt of the ACK and the original time stamp value and stores these in memory. Step 9 is the same as step 7 with the exception that mobile phone 12 transmits a directed distance detection request message to the mobile phone other than to which the first distance determination request was sent and step 10 is the same as step 9 with the same differences as noted for step 9.

Continuing to refer to FIG. 5b, at the completion of step 10 of the process, mobile phone 12 has all of the information it needs in order to calculate its geographic position which calculation will now be described with reference to step 11. Based on the information gathered and stored by mobile phone 12 up to this point in the process, I elected to use a technique known as triangulation to determine the geographic position of the mobile phone. In step 11 the GPD module is used to calculate the distances from mobile phone 12 to mobile phones 13 and 14 by using the values of the two time stamps generated and stored as the results of steps 7 to 10. The distance is calculated quite simply by using the two time stamp values to calculate the round trip time, divide this time by two to arrive at the one way time of flight for the message and then multiply this time by the speed of light. These two distances are then stored in memory. At this point the GPD module uses the GPS coordinate information received in the network discovery response messages to calculate the distance between mobile phones 13 and 14, in this case. Once the GPS position and distance between phones 13 and 14 is known, the GPD module can use the calculated distance from mobile phone 12 to mobile phones 13 and 14 and the triangulation technique mentioned above to calculate the geographic position of mobile phone 12. Alternatively, it may be desirable to verify the geographic position calculated in step 11 by comparing this geographic position to the last known GPS value contained in field 41c of the network discovery request packet 41 described with reference to FIG. 4a and stored in memory.

It should be understood that although I have described the preferred embodiment of my invention in the context of determining the round trip time between mobile phone 12 and mobile phones 3 and 4, my invention is not limited only to using RTT as I could have also elected to determine the geographic position of mobile phone 2 using a number of other techniques, for instance the angle at which the distance determines response messages arrive at mobile phone 2 or the time difference of arrival of these messages.

I claim:

1. In an ad hoc wireless communication network including a plurality of wireless: communication devices capable of receiving geographic positioning signals from a satellite, a method for determining the position of one of the wireless communication devices not currently able to receive a global positioning signal comprising the steps of:
a first one of the wireless communication devices detecting the absence of a geographic positioning signal and broadcasting a message to the other wireless communication devices within range that includes a request for the current geographic position information stored at the other wireless communication devices;
at least two of the other wireless communication devices receiving the broadcast geographic position request message sent by the first wireless communication device and each of the at least two other wireless communication devices responding by transmitting a message containing their geographic position information;
the first one of the wireless communication devices receiving a response from each of the at least two other wireless communication devices, detecting and storing an indication of the signal quality of the communication link over which each response message is transmitted and detecting and storing the geographic position information contained in each response message;
the first one of the wireless communication devices transmitting a first distance determination request message to a first one of the two other wireless communication devices and determining and storing the transmission time of the message;
the first one of the other plural wireless communication devices receiving the first distance determination request message and immediately sending a first distance determination response message to the first one of the wireless communication devices;
the first one of the wireless communication devices receiving the first distance determination response message, determining and storing the receiving time of the message and using the stored first distance determination request message transmission time and the stored first distance determination response message receiving time to calculate a first round trip time and storing the first round trip time;
the first one of the wireless communication devices transmitting a second distance determination request message to a second one of the two other wireless communication devices and determining and storing the transmission time of the message;
the second one of the other plural wireless communication devices receiving the second distance determination request message and immediately sending a second distance determination response message to the first one of the wireless communication devices;
the first one of the wireless communication devices receiving the second distance determination response message and determining and storing the receiving time of the message and using the stored second distance determination request message transmission time and the stored second distance determination response message receiving time to calculate a second round trip time and storing the second round trip time;
the first one of the wireless communication devices using the stored geographic position information received from each of the other first and second wireless communication devices to calculate a distance between the first and second other wireless communication devices and storing this as a first distance;
the first one of the wireless communication devices using the stored first round trip time to calculate a distance between it and the first one of the other two wireless communication devices and storing this as a second distance and the first one of the wireless communication devices using the stored second round trip time to calculate a distance between it and the second one of the other two wireless communication devices and storing this as a third distance; and
the first one of the wireless communication devices using a triangulation technique and the stored first, second and third distances and the stored geographic positions of the two other wireless communication devices to calculate its geographic position and storing this position.

2. The method of claim 1 further comprising the step of:
comparing the stored, calculated geographic position of the first wireless communication device with a last known geographic position of the first wireless communication device to be less than a predetermined distance and marking the stored, calculated geographic position of the first wireless communication device as a verified position.

3. the method of claim 1 wherein the step of calculating the second stored distance includes dividing the first stored round trip time by two and multiplying the result by the speed of light.

4. the method of claim 1 wherein the step of calculating the third stored distance includes dividing the second stored round trip time by two and multiplying the result by the speed of light.

5. the method of claim 1 in which at least the first communication device wireless is a mobile phone.

6. the mobile phone in claim 5 operates to transmit and receive any one of a voice message, a text message and an emergency message.

7. the calculated geographic position of the first wireless communication device of claim 1 is comprised of a latitudinal and a longitudinal coordinate.

8. the mobile phone of claim 5 operates according to cellular technology principles.
